(19) United States
(12) Patent Application Publication
(10) Pub. No.: US 2013/0055349 A1
(43) Pub. Date: Feb. 28, 2013

(54) METHOD AND APPARATUS FOR RELEASING TCP CONNECTIONS IN DEFENSE AGAINST DISTRIBUTED DENIAL OF SERVICE ATTACKS

(71) Applicant: Dae Won KIM, Daejeon (KR)

(72) Inventor: Dae Won KIM, Daejeon (KR)

(73) Assignee: Electronics and Telecommunications Research Institute, Daejeon (KR)

(21) Appl. No.: 13/590,096

(22) Filed: Aug. 20, 2012

(30) Foreign Application Priority Data
Aug. 24, 2011 (KR) 10-2011-0084833

(51) Int. Cl. G06F 21/20; G06F 21/00; G06F 15/16

(52) U.S. Cl. 726/3; 709/227; 726/22

(57) ABSTRACT

Disclosed are an apparatus and method for releasing a TCP connection against a denial-of-service attack. The TCP connection releasing method, which is a method for releasing a connection of a communication session between a server and a remote host, includes obtaining information included in a last ACK packet transmitted from the server to the remote host from a session table in which information on the communication session is recorded, generating an RST packet for requesting release of the communication session connection using the information on the obtained last ACK packet, and transmitting the generated RST packet to the server.

### CLAIM FOR PRIORITY

This application claims priority to Korean Patent Application No. 10-2011-0084833 filed on Aug. 24, 2011 in the Korean Intellectual Property Office (KIPO), the entire contents of which are hereby incorporated by reference.

### BACKGROUND

1. Technical Field

Example embodiments of the present invention relate in general to technology for defending against a denial-of-service attack or distributed denial-of-service attack, and more specifically, to a method and apparatus for releasing TCP connections against a denial-of-service attack that depletes TCP resources by occupying the resources for a long time.

2. Related Art

Since conventional denial-of-service attacks based on mass traffic are clearly distinguished from typical traffic, it becomes easier to block such attacks using distributed denial-of-service (DDoS) attack defense systems.

Therefore, to avoid the defense, recent denial-of-service attacks deplete service resources of a server by generating less intensive traffic. However, to deplete the resources of the server by generating less intensive traffic, a great number of so-called zombie hosts are required. From an attacker's perspective, it takes a long time to secure many zombie hosts, and the number of required zombie hosts for obtaining an effect of attack increases as the hardware performance of the server is improved.

To overcome these problems, attackers have devised techniques of a denial-of-service attack via less intensive traffic generated using small-scale zombie hosts. One of these techniques is to deplete allowable TCP connection resources for each service of a server. For this attack, software such as Slowloris, R.U.D.Y, OWASP HTTP post tool is typically used. These pieces of software may successfully carry out the denial-of-service attack using only several zombie hosts.

FIG. 1 is a conceptual diagram illustrating an example in which TCP connection resources are depleted by a denial-of-service attack.

Referring to FIG. 1, by using only one tool 1 (xxx.xxx.174.21) of the OWASP HTTP post, TCP connection resources allocated to an Apache web service of a server 2 (xxx.xxx.186.214:80) are depleted. Since all of currently allowable 386 TCP connection resources for the web service of the server 2 are depleted by the attack tool, new services for normal users are denied.

FIG. 2 illustrates an example of an attack using the R.U.D.Y. This attack tool establishes connection as illustrated in FIG. 2, and then, consistently and slowly sends packets to continuously occupy the corresponding TCP connection. Due to this attack, it may take about 13,888 days to receive originally intended 20 Mbytes of data. Further, service requests from normal users are continuously denied. To allow new service connections for normal users, the current TCP connections occupied by the attack tool should be released.

A typically used method for releasing the connections is to terminate and restart a service program, or to block packets from a remote host to be disconnected, by using an IP address and port number of the remote host as access control logic (ACL) for blocking, until timeout takes effect for releasing the TCP service connection.

However, when the service is terminated, services for normal users are also terminated, and a time taken for the timeout to take effect varies from dozens of seconds to dozens of minutes. Thus, the service denial to the normal users continues for the time taken for the timeout for releasing the TCP service connection to take effect.

### SUMMARY

Example embodiments of the present invention provide a method for instantly releasing a TCP connection to an attack host of a communication session which is considered to be used for an attack.

Example embodiments of the present invention provide an apparatus for instantly releasing a TCP connection to an attack host of a communication session which is considered to be used for an attack.

In some example embodiments, a method for releasing a connection of a communication session between a server and a remote host when release of the communication session connection is requested, includes obtaining information included in a last ACK packet transmitted from the server to the remote host from a session table in which information on the communication session is recorded, generating an RST packet for requesting release of the communication session connection using the information on the obtained last ACK packet, and transmitting the generated RST packet to the server, wherein the generated RST packet is the same as a packet generated to be transmitted from the remote host to the server in response to the last ACK packet, and an RST flag of a TCP header is set as ‘1’ for the RST packet.

Herein, when the server receives the RST packet, the server recognizes the RST packet as a connection release request from the remote host and releases the communication session connection.

Herein, the method further includes recording information on the remote host in an access control logic (ACL) table to block a connection request from the remote host when the communication session connection is released.

Herein, the information recorded in the session table includes basic information on the communication session and an ACK number of the last ACK packet, the basic information including a port number and IP address of the remote host.

Herein, the basic information on the communication session is recorded when the communication session is set up, and the ACK number of the last ACK packet is updated whenever an ACK packet is transmitted from the server to the remote host of the session.

Herein, the method further includes generating a base packet in the form of an RST packet transmitted to the server by obtaining an initial ACK packet transmitted from the server to a certain remote host, when the server is initially driven, and using pieces of address information included in the obtained initial ACK packet.

Herein, the RST packet is generated based on information included in the base packet, wherein information on the remote host that is to be included in the RST packet is generated using the information on the remote host of the communication session that is stored in the session table, and a sequence number of the RST packet is generated using an ACK number of the last ACK packet that is stored in the session table.

Herein, the request for release of the communication session is made when it is determined that the communication session is used for a denial-of-service attack.

In other example embodiments, a method for releasing a connection of a communication session between a server and a remote host includes generating a base packet in the form of a FIN packet transmitted to the server by obtaining an initial ACK packet transmitted from the server to a certain remote host, when the server is initially driven, and using information included in the obtained initial ACK packet, generating a FIN packet based on the base packet when release of the communication session connection is requested, and transmitting the generated FIN packet to the server so as to induce retransmission of a duplicate ACK (DUP ACK) packet from the server, wherein the generated FIN packet is the same as a packet generated to be transmitted from the remote host to the server, and a FIN flag of a TCP header is set as ‘1’ for the FIN packet. Herein, the method further includes intercepting the DUP ACK packet retransmitted from the server to the remote host in response to the FIN packet, generating an RST packet for requesting release of the communication session using an ACK number included in the DUP ACK packet, and transmitting the RST packet to the server.

Herein, the RST packet is generated based on the FIN packet, wherein an RST flag of the TCP header is set as ‘1’, and a sequence number is set using the ACK number included in the DUP ACK packet.

Herein, when the server receives the RST packet, the server recognizes the RST packet as a connection release request from the remote host and releases the communication session connection.

Herein, the method further includes recording information on the remote host in an access control logic (ACL) table to block a connection request from the remote host when the communication session connection is released.

Herein, the request for release of the communication session is made when it is determined that the communication session is used for a denial-of-service attack.

In still other example embodiments, an apparatus for releasing a connection of a communication session between a server and a remote host includes a session table in which basic information on the remote host of the communication session and information on a last ACK packet transmitted from the server of the communication session to the remote host of the communication session are recorded, an RST packet generating unit configured to generate an RST packet for requesting release of the communication session, when it is determined that the communication session is used for a denial-of-service attack, using the information on the last ACK packet recorded in the session table, and an RST packet transmitting unit configured to transmit the generated RST packet to the server of the communication session, wherein the generated RST packet is the same as a packet generated to be transmitted from the remote host of the communication session to the server in response to the last ACK packet, and an RST flag of a TCP header is set as ‘1’ for the RST packet.

Herein, the apparatus further includes a base packet generating unit configured to generate a base packet in the form of an RST packet transmitted to the server by obtaining an initial ACK packet transmitted from the server to a certain remote host, when the server is initially driven, and using information included in the obtained initial ACK packet, wherein the RST packet is generated based on information included in the base packet, wherein information on the remote host that is to be included in the RST packet is generated using the information on the remote host of the communication session that is stored in the session table, and a sequence number of the RST packet is generated using an ACK number of the last ACK packet that is stored in the session table.

Herein, when the server receives the RST packet, the server recognizes the RST packet as a connection release request from the remote host and releases the communication session connection.

In still other example embodiments, an apparatus for releasing a connection of a communication session between a server and a remote host includes a base packet generating unit configure to generate a base packet in the form of a FIN packet transmitted to the server by obtaining an initial ACK packet transmitted from the server to a certain remote host, when the server is initially driven, and using information included in the obtained initial ACK packet, a FIN packet generating unit configured to generate a FIN packet based on the base packet when it is determined that the communication session is used for a denial-of-server attack, and a FIN packet transmitting unit configured to transmit the generated FIN packet to the server so as to induce retransmission of a duplicate ACK (DUP ACK) packet from the server, wherein the generated FIN packet is the same as a packet generated to be transmitted from the remote host to the server, and a FIN flag of a TCP header is set as ‘1’ for the FIN packet.

Herein, the apparatus further includes a DUP ACK packet hooking unit configured to intercept and receive the DUP ACK packet retransmitted from the server to the remote host in response to the FIN packet, an RST packet generating unit configured to generate an RST packet for requesting release of the communication session connection, wherein a sequence number of the RST packet is generated using an ACK number included in the DUP ACK packet, and an RST packet transmitting unit configured to transmit the RST packet to the server.

### BRIEF DESCRIPTION OF DRAWINGS

The above and other features and advantages of the present invention will become more apparent by describing in detail example embodiments of the present invention with reference to the accompanying drawings, in which:

FIG. 1 is a conceptual diagram illustrating an example in which TCP connection resources are depleted by a denial-of-service attack;

FIG. 2 is a conceptual diagram illustrating an example of an R.U.D.Y denial-of-service attack;

FIG. 3 is a schematic conceptual diagram illustrating a TCP header structure;

FIG. 4 is a conceptual diagram illustrating a method for releasing a communication session connection according to the present invention;

FIG. 5 is a conceptual diagram illustrating a process for releasing a communication session connection according to an example embodiment of the present invention;

FIG. 6 is a block diagram illustrating an apparatus for releasing a communication session connection according to an example embodiment of the present invention;

FIG. 7 is a block diagram illustrating a structure of a session table according to an example embodiment of the present invention;

FIG. 8 is a conceptual diagram illustrating an example in which an ACK packet transmitted from a server to a host is obtained;

FIG. 9 is a conceptual diagram illustrating an example in which a base packet is generated according to an example embodiment of the present invention;

FIG. 10 is a conceptual diagram illustrating an example in which a base packet is changed to an RST packet, according to an example embodiment of the present invention;

FIG. 11 is a conceptual diagram illustrating a process for releasing a communication session connection according to another example embodiment of the present invention;

FIG. 12 is a block diagram illustrating an apparatus for releasing a communication session connection according to another example embodiment of the present invention;

FIG. 13 is a conceptual diagram illustrating an example in which a base packet is generated according to another example embodiment of the present invention; and

FIG. 14 is a conceptual diagram illustrating an example in which a base packet is changed to a FIN packet, according to another example embodiment of the present invention.

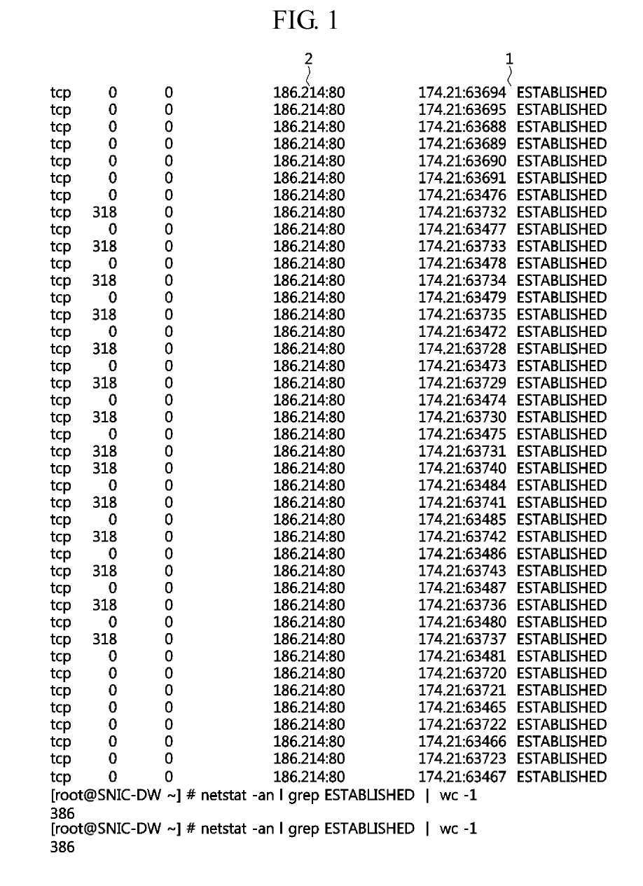

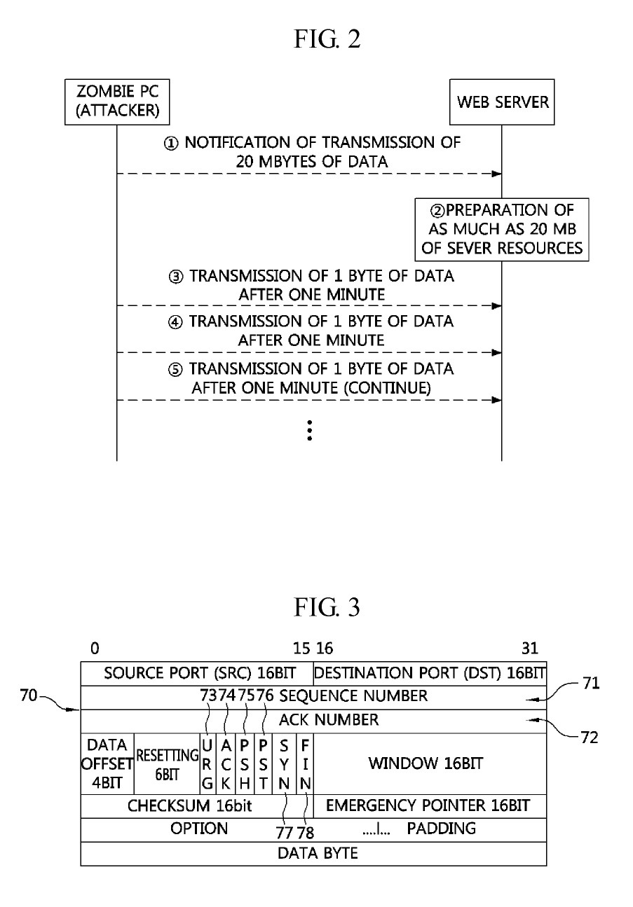

### DESCRIPTION OF EXAMPLE EMBODIMENTS

The invention may have diverse modified embodiments, and thus, example embodiments are illustrated in the drawings and are described in the detailed description of the invention. However, this does not limit the invention within specific embodiments and it should be understood that the invention covers all the modifications, equivalents, and replacements within the idea and technical scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the accompanying drawings.

The present invention provides a method and apparatus for instantly releasing only server-side TCP ESTABLISHED with respect to TCP ESTABLISHED connection established by an attack host. When the attack host-side TCP ESTABLISHED connection is released, partial attack tools may try to reestablish connections as many times as connections are released. Therefore, only the server-side TCP ESTABLISHED is released to deceive the attack tools into believing the attack is still successful.

Hereinafter, a TCP header structure as a basis of the method and apparatus for releasing a communication session connection, according to the present invention, will be described.

FIG. 3 is a schematic conceptual diagram illustrating the TCP header structure.

Referring to FIG. 3, the TCP header structure may be described as follows.

A TCP header 70 has a source port field and a destination port field. The source port field, which includes a service port number of a starting point, and the destination port field, which includes a service port number of a destination, are used for identifying a process or service at a receiving host. A unique sequence number of a packet is assigned to a sequence number field 71. This number is arbitrarily generated in a system during initial trial for connection, and the destination performs reconfiguration using this value.

Further, when packets are lost or arrive in wrong order, data are correctly rearranged using the sequence number field 71. A response number field 72 is used for transmitting and reassembling packets. For the received sequence number, an expected next octet is specified.

A flag field consisting of ‘URG’, ‘ACK’, ‘PSH’, ‘PST’, ‘SYN’, and ‘FIN’ specifies a service and an operation used while a session is performed. A URG flag 73 is used in an emergency situation. An ACK flag 74 indicates whether data have been correctly transmitted, wherein the ACK flag 74 is set as ‘1’ in the case of sending a packet in response to a packet received during a three-way handshake process.

A PSH flag 75 indicates that data of a corresponding segment should be instantly transmitted to an upper application program, and an RST flag 76 requests resetting of connection. An SYN flag 77 suggests session establishment, wherein the SYN flag 77 is set as ‘1’ when a session request packet is initially transmitted from a client to a server. An FIN flag 78 indicates that, when one side terminates a connection during bidirectional communication, the flow of data in this direction ends.

The present invention proposes a method for releasing a session connection used for an attack using assignment rules of a sequence number and ACK number and characteristics of an RST packet according to the above-described characteristics of the TCP header structure. Hereinafter, a basic concept of the method for releasing a communication session connection according to the present invention will be described.

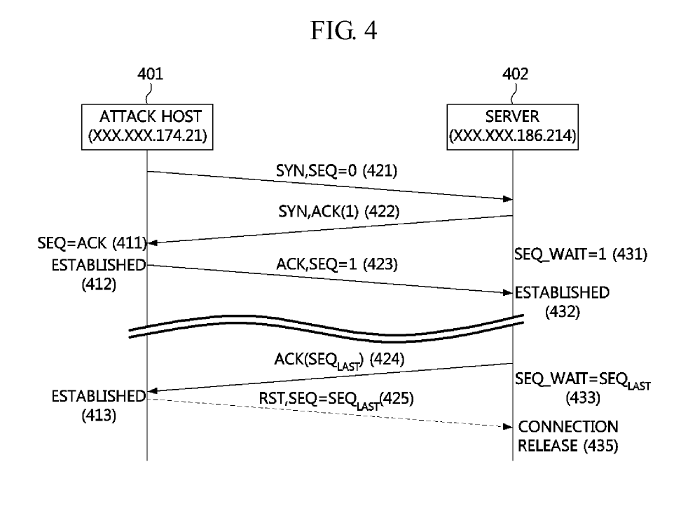

FIG. 4 is a conceptual diagram illustrating the method for releasing the communication session connection according to the present invention.

Referring to FIG. 4, there are packets transmitted before a TCP/IP communication session is established between a server 402 and a host 401, and there are packets transmitted for releasing the session connection.

According to the TCP protocol, a receiving side checks a sequence number of an arriving packet, and discards the packet if the sequence number is not an expected number. Further, as described above with reference to FIG. 3, according to the TCP protocol, a packet of which an RST flag is set as ‘1’ performs a function of requesting instant release of a TCP connection.

Further, an ACK number of an ACK packet 422 recently received from the server becomes a sequence number 411 that is to be transmitted next by the remote host 401, and the server 402 which has transmitted the ACK number waits for an ACK number 431 which has been transmitted as a sequence number of a packet to be received next.

In order to release server-side TCP ESTABLISHED 432, as indicated by a dotted arrow in FIG. 4, a packet 425 of which an RST flag having a sequence number of SEQ_{LAST} should be transmitted from the attack host 401 to the server 402.

A value of the SEQ_{LAST} needed for releasing (435) the TCP ESTABLISHED 432 may be extracted from an ACK number of a packet 424 last transmitted from the server 402 to the attack host 401. Based on these facts, the present invention proposes two methods for instantly releasing the server-side TCP ESTABLISHED session 432.

Hereinafter, connection release methods according to example embodiments of the present invention will be described with reference to the drawings.

### Embodiment 1

An example embodiment of the present invention provides a method and apparatus for setting an ACK number of an ACK packet last transmitted from a server to a host as a sequence number of an RST packet, while constantly maintaining the ACK number. This embodiment is described in detail below with reference to the drawings.

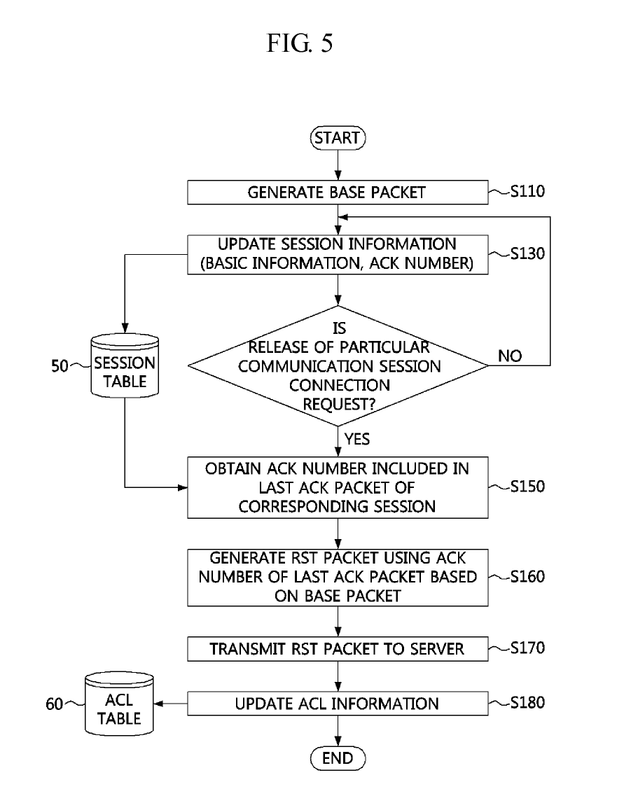

FIG. 5 is a conceptual diagram illustrating a process for releasing a communication session connection according to an example embodiment of the present invention.

An example embodiment of the present invention, which will be described with reference to FIG. 5, provides a technique of requesting release of a connection by transmitting an RST packet to a server.

Referring to FIG. 5, the process for releasing a communication session connection between a server and a remote host, according to an example embodiment of the present invention, includes base packet generating operation S110, session information updating operation S130, last ACK number obtaining operation S150, RST packet generating operation S160, RST packet transmitting operation S170, and ACL information updating operation S180.

In base packet generating operation S110, when a server is initially driven, an initial ACK packet transmitted from the server to a certain remote host is obtained, and a base packet is generated in the form of an RST packet transmitted to the server using pieces of basic information included in the obtained initial ACK packet. This operation is performed only once when the server is initially driven, and pieces of basic information included in the generated base packet are referred to when an RST packet is generated for releasing a session connection.

The basic information may include a remote MAC address and a server-side window size. Since pieces of basic information for generating a packet may be simply collected without obtaining an ACK packet, the packet may be generated using the collected information. The packet may be obtained or generated with a size of 54 bytes.

Herein, the certain remote host may be or may not be a host of the corresponding session. The base packet is initially generated once so as to refer to the basic information included therein, i.e., address information on the server and the like, and thus is not limited by the remote host.

In session information updating operation S130, when a communication session is set up, basic information on the communication session, for example, a remote host IP address and port number of the communication session, is recorded. Further, whenever an ACK packet is transmitted from the server to the remote host of the corresponding session, an ACK number included in the ACK packet is recorded in a session table. That is, the session table is updated so that a number of an ACK packet most recently transmitted from the server to the host of the session is maintained.

Above described operations S110 and S130 are performed regardless of whether release of a corresponding session connection is requested or not. These operations may be for maintaining basic information for releasing a connection when it is determined that a certain session is used for, for example, a denial-of-service attack. Further, these operations, which are performed in consideration of efficiency of system performance, are optional rather than essential.

The operations described below are performed when a connection to a particular communication is requested to be released.

In last ACK number obtaining operation S150, information included in an ACK packet last transmitted from a communication session requested to be disconnected to the remote host is obtained from the session table in which information on the communication session is recorded. That is, an ACK number of the last transmitted ACK packet, which is recorded in the session table as described above, is obtained from the session number.

In RST packet generating operation S160, by using the previously obtained information on the last ACK packet, i.e., by using the ACK number, an RST packet for requesting release of the corresponding communication session is generated. Herein, the RST packet is generated in the same manner as a packet that is generated to be transmitted from the remote host to the server in response to the ACK packet last transmitted from the server of the corresponding session to the remote host. Therefore, a flag of the RST packet is set as ‘1’, and the last ACK packet number obtained from the session table becomes a sequence number of the RST packet. Further, the information included in the base packet generated when the server is initially driven is used for destination information which should be recorded in the RST packet.

The generation of the RST packet using the base packet will be described in detail later.

In RST packet transmitting operation S170, the generated RST packet is transmitted to the server of the corresponding communication session. When the RST packet is transmitted to the server, the server recognizes this packet as a connection release request from the host and thus releases the connection.

In ACL information updating operation S180, information on the connection-released remote host is recorded in an access control logic (ACL) table. That is, by recording the information on the host in the ACL table, when a connection is requested later, this request may be blocked.

Hereinafter, elements of an apparatus for releasing a communication session connection, according to an example embodiment of the present invention, and connection relations among the elements will be described.

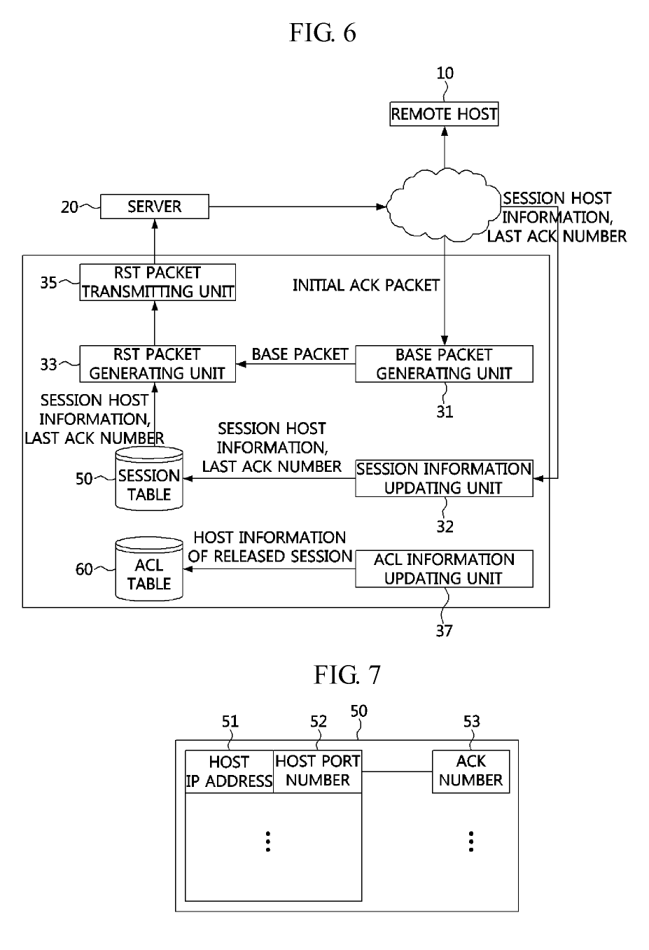

FIG. 6 is a block diagram illustrating the communication session connection releasing apparatus according to an example embodiment of the present invention.

FIG. 7 is a conceptual diagram illustrating a structure of a session table according to an example embodiment of the present invention.

Referring to FIG. 6, the communication session connection releasing apparatus according to an example embodiment of the present invention includes a base packet generating unit 31, a session information updating unit 32, an RST packet generating unit 33, an RST packet transmitting unit 34, an ACL information updating unit 37, a session table 50, and an ACL table 60.

Referring to FIG. 6, the communication session connection releasing apparatus is described below.

The base packet generating unit 31 obtains, when a server 20 of a communication session is initially driven, an initial ACK packet transmitted from the server to a certain remote host so as to generate, using pieces of address information included in the initial ACK packet, a base packet in the form of an RST packet transmitted to the server 20 of the session.

Herein, the certain remote host may be or may not be a host of the corresponding session. The base packet is initially generated once so as to refer to the basic information included therein, i.e., address information on the server and the like, and thus is not limited by the remote host.

The session information updating unit 32 records basic information on the communication session, for example, a remote host IP address 51 and port number 52 of the communication session in the session table 50 whenever the communication session is set up. Further, whenever an ACK packet is transmitted from the server 20 to the remote host 10 of the corresponding session, an ACK number 53 included in the ACK packet is recorded in the session table 50. That is, the session table 50 is updated so that a number 53 of an ACK packet most recently transmitted from the server 20 to the host 10 of the session is maintained.

The RST packet generating unit 33, by using the information on the last ACK packet recorded in the session table 50, generates an RST packet of which an RST flag is set as ‘1’, for requesting release of the corresponding communication session connection when it is determined that the corresponding session is used for a denial-of-service attack. Herein, the RST packet is the same as a packet that is generated to be transmitted from the remote host of the communication session to the server in response to the last ACK packet.

Further, the RST packet is generated based on the information included in the base packet generated by the base packet generating unit 31, wherein information on the remote host 10 that is to be included in the RST packet is generated using the information on the remote host of the communication session that is stored in the session table 50, and a sequence number of the RST packet is set as the ACK number 53 of the last ACK packet that is stored in the session table 50.

The RST packet transmitting unit 34 transmits the generated RST packet to the server 20 of the session. The server which received the RST packet terminates the corresponding communication session.

The ACL information updating unit 37 records information on the remote host of the connection-released session in the ACL table 60. That is, by recording the information on the host in the ACL table 60, when a connection is requested later, this request may be blocked.

As described above, the session table 50 records, whenever a session is established, information on the session, for example, the IP address and port number of the host, and updates an ACK number of an ACK packet whenever the ACK packet is transmitted from the server to the host via the session.

Referring to FIG. 7, the session table 50 includes an IP address 51 of a remote host, a port number 52 thereof, and the ACK number 53 of the ACK packet last transmitted from the server 20 to the host 10.

The apparatus according to the present example embodiment may be configured to constantly operate in a server. In the case of implementing the apparatus in the form of hardware, the apparatus may be applied in the form of a network security system located between a remote host and a server, or in the form of a network interface card (NIC) installed in the server. The server waits for the remote host requesting a service to connect thereto via a particular service port number Sport of the server with respect to a main service such as a web service.

Hereinafter, a change of a field of a packet for each process for the above-described communication session connection releasing will be described with reference to the drawings.

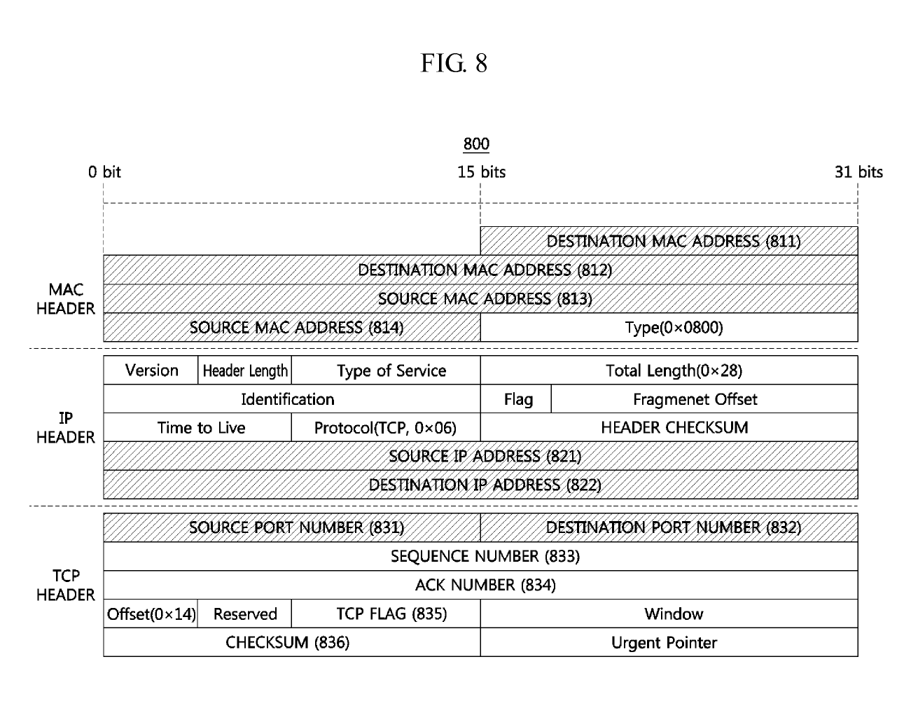

FIG. 8 is a conceptual diagram illustrating an example in which an ACK packet transmitted from a server to a host is obtained. FIG. 8 illustrates an example of the initial packets obtained in base packet generating operation S210 of FIG. 5 and obtained by the base packet generating unit 41 of FIG. 6.

Referring to FIG. 8, when a main service of the server is driven, one ACK packet Pack being transmitted from the port Sport of the server 20 to the remote host 10 is obtained so as to illustrate information included in a packet stored in a memory.

The packet includes basic information needed for generating an RST packet, wherein the basic information includes destination MAC addresses 811 and 812 and a size of a server-side window.

The packet records pieces of address information (grey fields in FIG. 8) for proceeding from the server 20 of the session to the remote host 10, and, by modifying the packet, a packet having a form for being transmitted from the remote host 10 to the server 20 is generated.

The pieces of address information shown in FIG. 8, i.e., values of respective fields, are expressed as follows.

Smac: an MAC address of the server=source MAC addresses 813 and 814 of a current packet

Sip: an IP address of the server=a source IP address 821 of the current packet

Sport: a service port number of the server=a source port number 831 of the current packet

Rmac: a remote MAC address=destination MAC addresses 811 and 812 of the current packet

Rip: an IP address of the remote host=a destination IP address 822 of the current packet

Rpot: a port number of the remote host=a destination port number 832 of the current packet

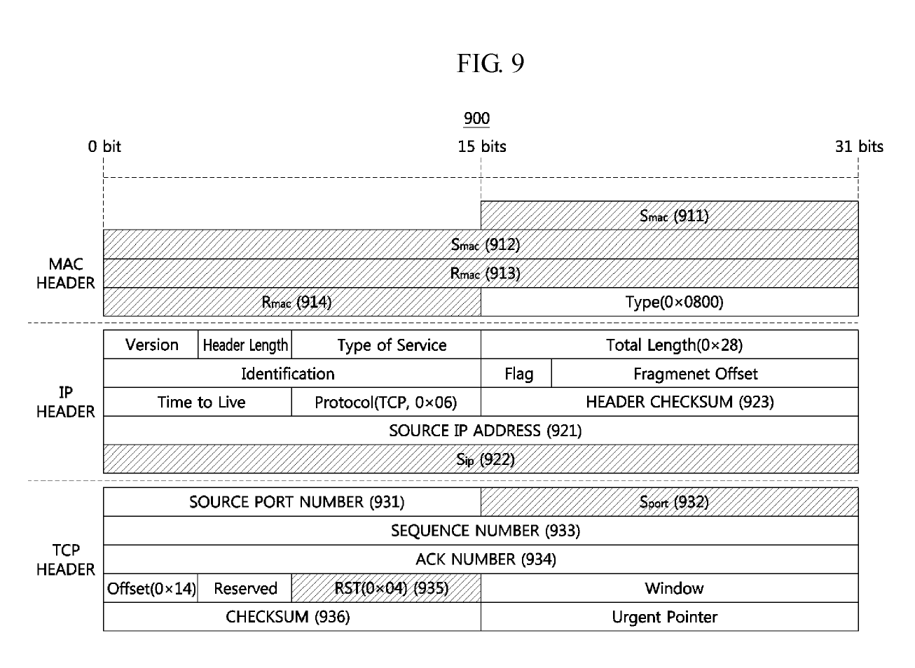

FIG. 9 is a conceptual diagram illustrating an example in which the base packet is generated according to an example embodiment of the present invention.

Referring to FIG. 9, values of respective fields included in the base packet generated based on the packet of FIG. 8, i.e., included in a packet having a form for being transmitted from the host 10 to the server 20, are illustrated.

Referring to FIG. 9, the destination MAC addresses 811 and 812, source MAC addresses 813 and 814, destination IP address 822, and destination port number 832 of the packet 800 of FIG. 8 are respectively changed to the Smacs 911 and 912, Rmacs 913 and 914, Sip 922, and Sport 932 of the packet 900 of FIG. 9, and only an RST flag 935 of a TCP header is set as ‘1’ to thereby generate the base packet 900. In this manner, the generation of the base packet 900 for transmitting an RST packet to the server is completed.

When connection release is requested with respect to a particular session, or when it is determined that the connection release is needed, an RST packet to be transmitted to the server is generated.

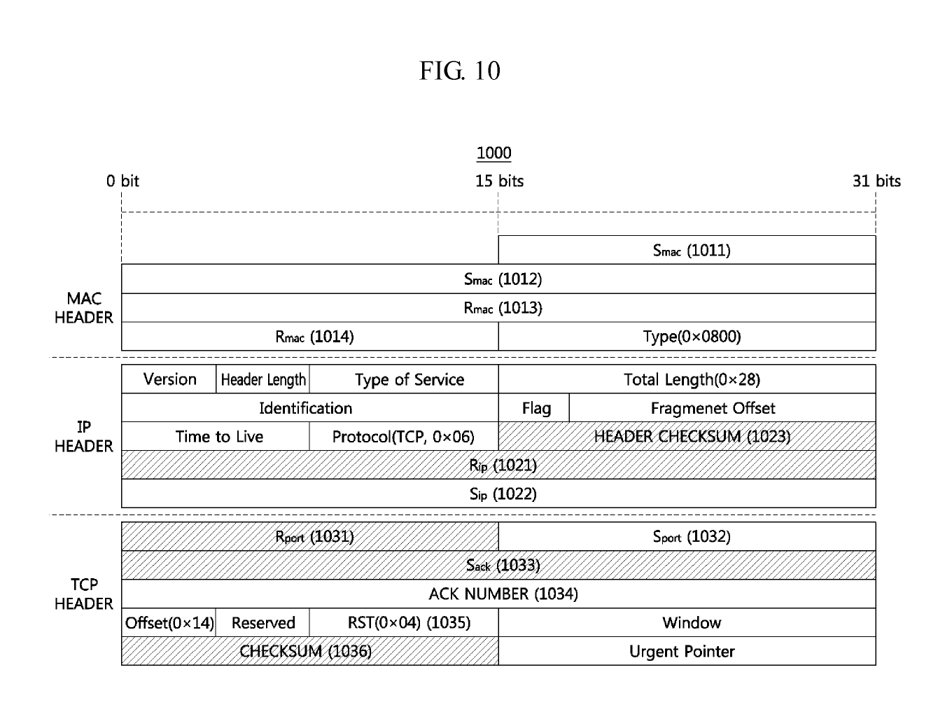

FIG. 10 is a conceptual diagram illustrating an example in which a base packet is changed to an RST packet, according to an example embodiment of the present invention.

Referring to FIG. 10, values of respective fields included in an RST packet 1000 generated based on the base packet 900 of FIG. 9 are illustrated. Grey fields 1021, 1023, 1031, 1033 and 1036 are different parts from the base packet 900.

It is understood that the fields corresponding to the source IP address 921 and source port number 931 of the base packet 900 are changed to the IP address and port number of the host 10 of the corresponding session, i.e., Rip 1021 and Rport 1031.

Further, the ACK number 53 of the packet last transmitted from the server 20 of the corresponding session to the host 10 is obtained from the session table 50 in order to set a sequence number Sack of the RST packet 1000 in a sequence number field 1033.

A checksum 1023 of the IP header and a checksum 1036 of the TCP header are calculated using the changed current RST packet information so as to generate the completed RST packet 1000.

When this RST packet 1000 is transmitted to the server 20, this transmission causes an effect of transmitting the RST packet 1000 from the remote host 10 to the server 20, and thus, the server-side ESTABLISHED is instantly released. On the contrary, in the remote host 10 which is considered as an attack host, the TCP ESTABLISHED state is still maintained. Therefore, the attack tool mistakenly determines that the attack is still successfully carried out, and thus does not additionally carry out an attack before the ESTABLISHED is automatically released due to the timeout.

Since the remote host 10 may carry out an attack again when the TCP ESTABLISHED is released due to the timeout, the IP address of the remote host is registered in the ACL table 60 to block packets from the remote host 10.

As an application of the method of Embodiment 1, without generating a base packet, not only an ACK number but also the whole ACK packet transmitted from the server to the remote host or 54 bytes of the ACK packet may be stored in the session table. However, it may be preferable to use the base packet since processing performance is excellent in terms of software implementation, and memory usage is efficient in terms of hardware implementation.

In the case of the method of Embodiment 1, regardless of whether the server is attacked, a server-side ACK packet should be always monitored or hooked, and the server may be continuously loaded in the case of software implementation.

Another example embodiment for overcoming the above-described limitation will be described. This method may be implemented in the form of hardware as well as software.

### Embodiment 2

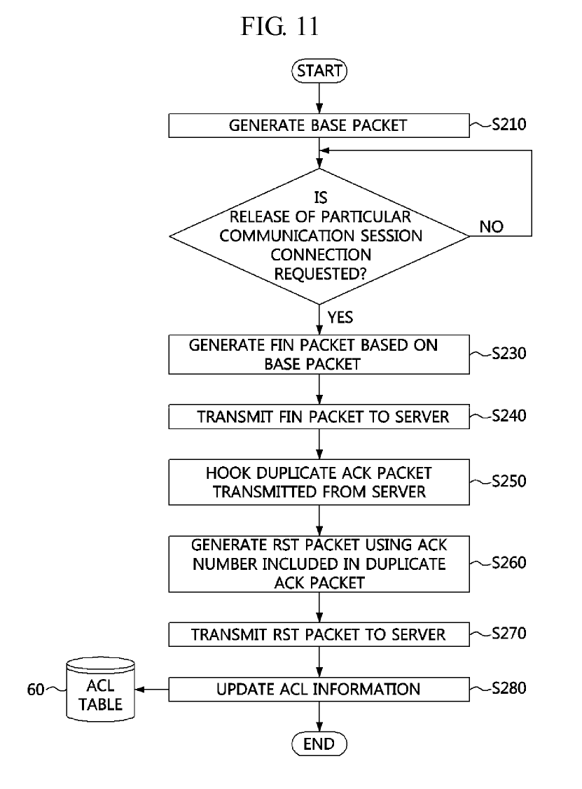

FIG. 11 is a conceptual diagram illustrating a process for releasing a communication session connection according to another example embodiment of the present invention.

Another example embodiment of the present invention, which will be described with reference to FIG. 11, provides a technique in which a FIN packet is transmitted to a server before transmitting an RST packet, and an ACK number is obtained from a duplicate ACK packet transmitted in response to the FIN packet.

Referring to FIG. 11, the process for releasing a communication session connection between a server and a remote host, according to another example embodiment of the present invention, includes base packet generating operation S210, FIN packet generating operation S230, FIN packet transmitting operation S240, DUP ACK packet hooking operation S250, RST packet generating operation S260, RST packet transmitting operation S270, and ACL information updating operation S280.

In base packet generating operation S210, when a server is initially driven, an initial ACK packet transmitted from the server to a certain remote host is obtained, and a base packet is generated in the form of an RST packet transmitted to the server using pieces of basic information included in the obtained initial ACK packet. This operation is performed only once when the server is initially driven, and pieces of basic information included in the generated base packet are referred to when an RST packet is generated for releasing a session connection.

The basic information may include a remote MAC address and a server-side window size. Since pieces of basic information for generating a packet may be simply collected without obtaining an ACK packet, the packet may be generated using the collected information. The packet may be obtained or generated with a size of 54 bytes.

Herein, the certain remote host may be or may not be a host of the corresponding session. The base packet is initially generated once so as to refer to the basic information included therein, i.e., address information on the server and the like, and thus is not limited by the remote host.

Base packet generating operation S210 is performed regardless of whether release of a corresponding session connection is requested or not. This operation may be for maintaining basic information for releasing a connection when it is determined that a certain session is used for, for example, a denial-of-service attack. Further, this operation, which is performed in consideration of efficiency of system performance, is optional rather than essential.

The operations described below are performed when a connection to a particular communication is requested to be released.

In FIN packet generating operation S230, a FIN packet is generated based on a pre-generated base packet in the case where a connection to a particular communication session is requested to be released. Herein, the FIN packet is the same as a packet generated to be transmitted from the remote host to the server, wherein a FIN flag of the packet is set as ‘1’. In this case, since an ACK number of an ACK packet last transmitted from the server of the corresponding session to the remote host cannot be known, a sequence number field of the generated FIN packet includes a wrong number.

In FIN packet transmitting operation S240, the generated FIN packet is transmitted to the server of the session. The server, which received the FIN packet with an incorrect sequence number as described above, retransmits a duplicate ACK (DUP ACK) packet to the remote host, according to the TCP protocol.

In DUP ACK packet hooking operation S250, the DUP ACK packet retransmitted from the server to the remote host in response to the FIN packet is intercepted. Since the ACK number of the ACK packet last transmitted from the server to the host is recorded in the DUP ACK packet, this number is used as a sequence number of an RST packet for blocking the server-side TCP ESTABLISHED.

In RST packet generating operation S260, by using the ACK number included in the DUP ACK packet, an RST packet for requesting release of the corresponding communication session is generated. Herein, the RST packet may be generated based on the FIN packet or base packet. However, an RST flag of the TCP header is set as ‘1’, and a sequence number is set using the ACK number included in the DUP ACK packet.

In RST packet transmitting operation S270, the generated RST packet is transmitted to the server of the corresponding communication session. When the RST packet is transmitted to the server, the server recognizes this packet as a connection release request from the host and thus releases the connection.

In ACL information updating operation S280, information on the remote host of the connection-released session is recorded in an ACL table. That is, by recording the information on the host in the ACL table, when a connection is requested later, this request may be blocked.

Hereinafter, elements of an apparatus for releasing a communication session connection, according to another example embodiment of the present invention, and connection relations among the elements will be described.

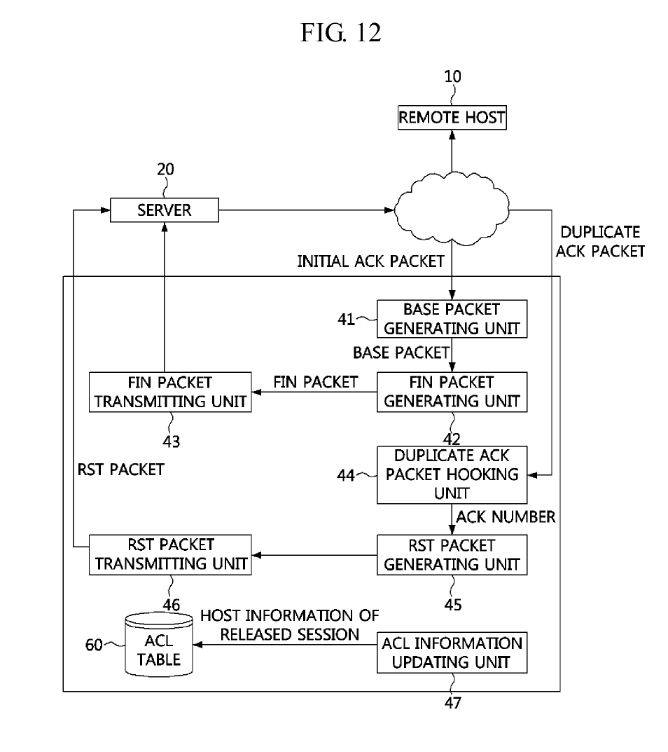

FIG. 12 is a block diagram illustrating the communication session connection releasing apparatus according to another example embodiment of the present invention.

Referring to FIG. 12, the communication session connection releasing apparatus according to another example embodiment of the present invention includes a base packet generating unit 41, a FIN packet generating unit 42, a FIN packet transmitting unit 43, a duplicate ACK packet hooking unit 44, an ACL information updating unit 47, and an ACL table 60.

Referring to FIG. 12, the communication session connection releasing apparatus according to another example embodiment of the present invention is described below.

The base packet generating unit 41 obtains, when a server 20 of a communication session is initially driven, an initial ACK packet transmitted from the server to a certain remote host so as to generate, by using pieces of address information included in the initial ACK packet, a base packet in the form of a FIN packet transmitted to the server 20 of the session.

Herein, the certain remote host may be or may not be a host of the corresponding session. The base packet is initially generated once so as to refer to the basic information included therein, i.e., address information on the server and the like, and thus is not limited by the remote host.

The FIN packet generating unit 42 generates a FIN packet based on a pre-generated base packet in the case where a connection to a particular communication session is requested to be released. Herein, the FIN packet is the same as a packet generated to be transmitted from the remote host 10 to the server 20, wherein a FIN flag of the packet is set as ‘1’. In this case, since an ACK number of an ACK packet last transmitted from the server of the corresponding session to the remote host 10 cannot be known, a sequence number field of the generated FIN packet includes a wrong number.

The FIN packet transmitting unit 43 transmits the generated FIN packet to the server 20 of the session. The server 20, which received the FIN packet with an incorrect sequence number as described above, retransmits a DUP ACK to the remote host 10, according to the TCP protocol.

The DUP ACK packet hooking unit 44 intercepts the DUP ACK packet retransmitted from the server 20 to the remote host 10 in response to the FIN packet. Since the ACK number of the ACK packet last transmitted from the server 20 to the host 10 is recorded in the DUP ACK packet, this number is used as a sequence number of an RST packet for blocking the server-side TCP ESTABLISHED.

The RST packet generating unit 45, by using the ACK number included in the DUP ACK packet, generates an RST packet for requesting release of the corresponding communication session. Herein, the RST packet may be generated based on the FIN packet or base packet. However, an RST flag of the TCP header is set as ‘1’, and a sequence number is set using the ACK number included in the DUP ACK packet.

The RST packet transmitting unit 46 transmits the generated RST packet to the server 20 of the session. The server 20 receiving the RST packet terminates the corresponding communication session.

The ACL information updating unit 47 records information on the remote host of the connection-released session in the ACL table 60. That is, by recording the information on the host 10 in the ACL table 60, when a connection is requested later, this request may be blocked.

Hereinafter, a change of a field of a packet, according to the base packet and FIN packet generating operations among the above-described processes for releasing a communication session connection, will be described with reference to the drawings.

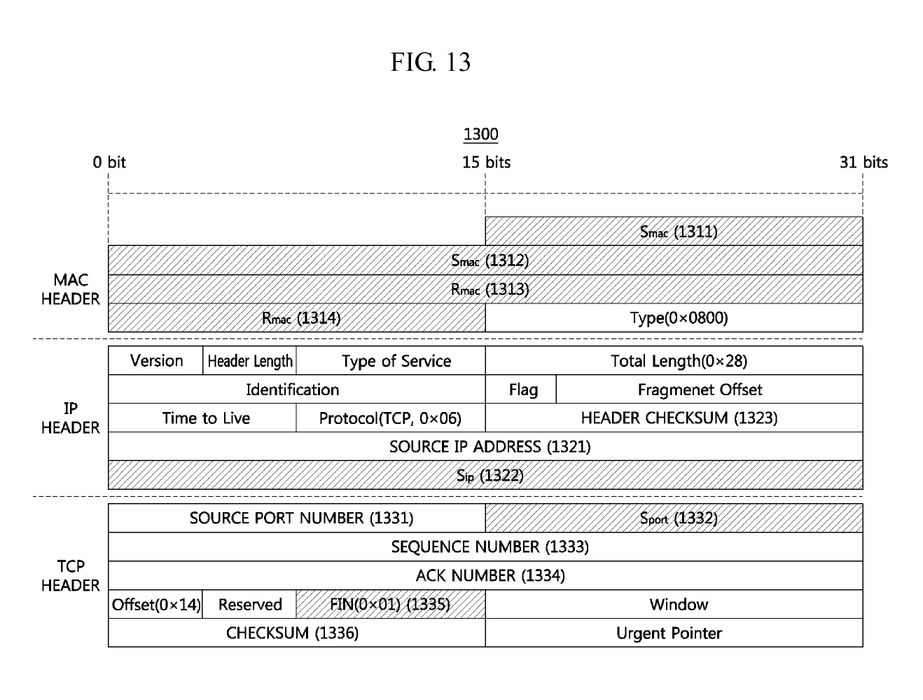

FIG. 13 is a conceptual diagram illustrating an example in which the base packet is generated according to another example embodiment of the present invention.

Referring to FIG. 13, values of respective fields included in the base packet generated based on a packet transmitted from a server to a certain host of FIG. 8, i.e., included in a packet having a form for being transmitted from the host 10 to the server 20, are illustrated.

Referring to FIG. 13, the destination MAC addresses 811 and 812, source MAC addresses 813 and 814, destination IP address 822, and destination port number 832 of the packet 800 of FIG. 8 are respectively changed to the Smacs 1311 and 1312, Rmacs 1313 and 1314, Sip 1322, and Sport 1332 of the packet 1300 of FIG. 13, and a FIN flag 1335 of a TCP header is set as ‘1’ to thereby generate the base packet 1300. In this manner, the generation of the base packet 1300 for transmitting a FIN packet to the server is completed.

When connection release is requested with respect to a particular session, or when it is determined that the connection release is needed, a FIN packet to be transmitted to the server is generated.

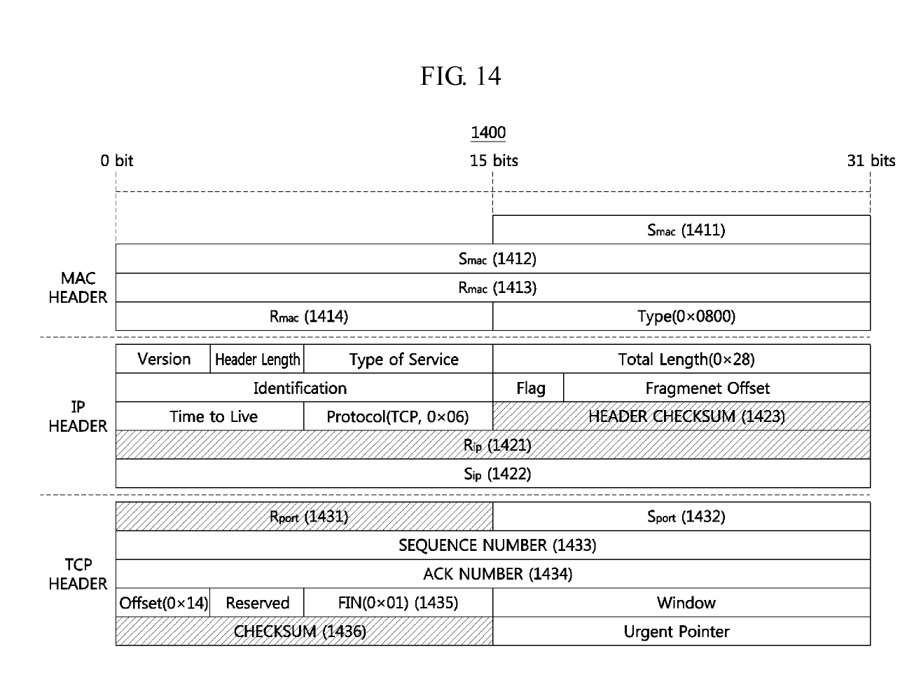

FIG. 14 is a conceptual diagram illustrating an example in which a base packet is changed to a FIN packet, according to another example embodiment of the present invention.

Referring to FIG. 14, values of respective fields included in a FIN packet 1400 generated based on the base packet 1300 of FIG. 13 are illustrated. Grey fields 1421, 1423, 1431, and 1436 are different parts from the base packet 1300.

It is understood that the fields corresponding to the source IP address 1321 and source port number 1331 of the base packet 1300 are changed to the IP address and port number of the host 10 of the corresponding session, i.e., Rip 1421 and Rport 1431.

Herein, since a final ACK number cannot be known, a sequence number 1433 is not changed. A checksum 1423 of the IP header and a checksum 1436 of the TCP header are calculated using the changed current FIN packet information so as to generate the completed FIN packet 1400.

When this FIN packet 1400 is transmitted to the server 20, according to the TCP protocol, the server 20 retransmits the duplicate ACK packet to the remote host R in response to the FIN packet 1400 having an incorrect sequence number. A server-side ACK number recorded in this duplicate ACK packet is used as a sequence number of an RST packet for blocking the server-side TCP ESTABLISHED.

Therefore, after transmitting the FIN packet 1400, it is necessary to monitor or hook the duplicate ACK packet just for a while. Thus, it is not necessary to continuously monitor or hook a packet, unlike the method of Embodiment 1, thereby improving performance.

A packet capture program “wireshark” expresses the duplicate ACK packet in the form of information shown in Table 1.

TABLE 1

| No | Time | Source | Destination | Protocol | Info |
|---|---|---|---|---|---|
| 3099 | 47.262406 | xxx.xxx.186.214 | xxx.xxx.174.21 | TCP | [TCP Dup ACK 579#1] http>59230[ACK] |
| | | | | | Seq=1 Ack=319 Win=6432 Len=0 |
| | | | | | SLE=2265829617 SRE=2265829618 |

The RST packet generated in a following process is the same as the RST packet 1000 of FIG. 10.

According to the above-described methods and apparatuses for releasing a TCP connection against a denial-of-service attack, an RST packet for instantly releasing the server-side TCP ESTABLISHED session is generated by instantly obtaining a server-side ACK number, and the generated RST packet is transmitted. Therefore, service requests from normal users can be instantly accepted within the limits of availability caused by the release of the TCP ESTABLISHED connection. Further, since only the server-side TCP ESTABLISHED connection is released, the attack tool of the attack host is deceived into believing the attack is still successful.

While example embodiments of the present invention and their advantages have been described in detail, it should be understood that various changes, substitutions and alterations may be made herein without departing from the scope of the invention.

What is claimed is:

1. A method for releasing a connection of a communication session between a server and a remote host when release of the communication session connection is requested, the method comprising:
obtaining information included in a last ACK packet transmitted from the server to the remote host from a session table in which information on the communication session is recorded;
generating an RST packet for requesting release of the communication session connection using the information on the obtained last ACK packet; and
transmitting the generated RST packet to the server,
wherein the generated RST packet is the same as a packet generated to be transmitted from the remote host to the server in response to the last ACK packet, and an RST flag of a TCP header is set as ‘1’ for the RST packet.

2. The method of claim 1, wherein when the server receives the RST packet, the server recognizes the RST packet as a connection release request from the remote host and releases the communication session connection.

3. The method of claim 2, further comprising recording information on the remote host in an access control logic (ACL) table to block a connection request from the remote host when the communication session connection is released.

4. The method of claim 1, wherein the information recorded in the session table comprises basic information on the communication session and an ACK number of the last ACK packet, the basic information comprising a port number and IP address of the remote host.

5. The method of claim 4, wherein the basic information on the communication session is recorded when the communication session is set up, and the ACK number of the last ACK packet is updated whenever an ACK packet is transmitted from the server to the remote host of the session.

6. The method of claim 1, further comprising generating a base packet in the form of an RST packet transmitted to the server by obtaining an initial ACK packet transmitted from the server to a certain remote host, when the server is initially driven, and using pieces of address information included in the obtained initial ACK packet.

7. The method of claim 6, wherein the RST packet is generated based on information included in the base packet,
wherein information on the remote host that is to be included in the RST packet is generated using the information on the remote host of the communication session that is stored in the session table, and
a sequence number of the RST packet is generated using an ACK number of the last ACK packet that is stored in the session table.

8. The method of claim 1, wherein the request for release of the communication session is made when it is determined that the communication session is used for a denial-of-service attack.

9. A method for releasing a connection of a communication session between a server and a remote host, the method comprising:
generating a base packet in the form of a FIN packet transmitted to the server by obtaining an initial ACK packet transmitted from the server to a certain remote host, when the server is initially driven, and using information included in the obtained initial ACK packet;
generating a FIN packet based on the base packet when release of the communication session connection is requested; and
transmitting the generated FIN packet to the server so as to induce retransmission of a duplicate ACK (DUP ACK) packet from the server,
wherein the generated FIN packet is the same as a packet generated to be transmitted from the remote host to the server, and a FIN flag of a TCP header is set as ‘1’ for the FIN packet.

10. The method of claim 9, further comprising:
intercepting the DUP ACK packet retransmitted from the server to the remote host in response to the FIN packet;
generating an RST packet for requesting release of the communication session using an ACK number included in the DUP ACK packet; and
transmitting the RST packet to the server.

11. The method of claim 10, wherein the RST packet is generated based on the FIN packet, wherein an RST flag of the TCP header is set as ‘1’, and a sequence number is set using the ACK number included in the DUP ACK packet.

12. The method of claim 10, wherein when the server receives the RST packet, the server recognizes the RST packet as a connection release request from the remote host and releases the communication session connection.

13. The method of claim 12, further comprising recording information on the remote host in an access control logic (ACL) table to block a connection request from the remote host when the communication session connection is released.

14. The method of claim 9, wherein the request for release of the communication session is made when it is determined that the communication session is used for a denial-of-service attack.

15. An apparatus for releasing a connection of a communication session between a server and a remote host, the apparatus comprising:
a session table in which basic information on the remote host of the communication session and information on a last ACK packet transmitted from the server of the communication session to the remote host of the communication session are recorded;
an RST packet generating unit configured to generate an RST packet for requesting release of the communication session, when it is determined that the communication session is used for a denial-of-service attack, by using the information on the last ACK packet recorded in the session table; and
an RST packet transmitting unit configured to transmit the generated RST packet to the server of the communication session,
wherein the generated RST packet is the same as a packet generated to be transmitted from the remote host of the communication session to the server in response to the last ACK packet, and an RST flag of a TCP header is set as ‘1’ for the RST packet.

16. The apparatus of claim 15, further comprising:
a base packet generating unit configured to generate a base packet in the form of an RST packet transmitted to the server by obtaining an initial ACK packet transmitted from the server to a certain remote host, when the server is initially driven, and using information included in the obtained initial ACK packet,
wherein the RST packet is generated based on information included in the base packet,
information on the remote host that is to be included in the RST packet is generated using the information on the remote host of the communication session that is stored in the session table, and
a sequence number of the RST packet is generated using an ACK number of the last ACK packet that is stored in the session table.

17. The apparatus of claim 16, wherein when the server receives the RST packet, the server recognizes the RST packet as a connection release request from the remote host and releases the communication session connection.
